(19) United States
(12) Patent Application Publication
(10) Pub. No.: US 2026/0148548 A1
(43) Pub. Date: May 28, 2026

(54) METHOD AND COMPUTING DEVICE FOR MANAGING FIELD

(71) Applicant: URSrobot AI Inc., Taipei City (TW)

(72) Inventors: Shih-Yu CHEN, Taipei City (TW); Bing-Yan JIANG, Taipei City (TW); Chung-Hou WU, Taipei City (TW); Chao-Cheng CHEN, Taipei City (TW)

(21) Appl. No.: 19/256,406

(22) Filed: Jul. 1, 2025

(30) Foreign Application Priority Data
Nov. 22, 2024 (TW) 113145099

(51) Int. Cl. G06V 20/10; G06T 7/90; G06V 10/762; G06V 10/764

(52) U.S. Cl. CPC G06V 20/188; G06T 7/90; G06V 10/762; G06V 10/764; G06T 2207/10024; G06T 2207/30188

(57) ABSTRACT

A method includes steps of: for each of plural pixels of a field image of a field, calculating a green index for quantifying green color of the pixel based on a set of RGB channel values of the pixel; performing a clustering algorithm on the pixels of the field image to group the pixels into a green cluster and a non-green cluster according to the green indexes of the pixels of the field image; calculating one of a green-grass coverage and a green-grass vegetation index based on pixels of the green cluster and the pixels of the field image; and outputting the one of the green-grass coverage and the green-grass vegetation index to an irrigation system for the irrigation system to automatically maintain the field by one of irrigating the field and fertilizing the field based on the one of the green-grass coverage and the green-grass vegetation index.

### CROSS-REFERENCE TO RELATED APPLICATION

This application claims priority to Taiwanese Invention Patent Application No. 113145099, filed on November 22, 2024, the entire disclosure of which is incorporated by reference herein.

### FIELD

The disclosure relates to a method and a computing device for managing a field, and more particularly to a method and a computing device for managing a field by using techniques of image processing.

### BACKGROUND

Conventionally, a lawn care manager manually maintains a lawn (e.g., conducts routine site inspections in person) to ensure desired quality of the lawn. However, such way of maintaining a lawn is labor-intensive, time-consuming, inefficient, and often inconvenient for a lawn care manager.

### SUMMARY

Therefore, an object of the disclosure is to provide a method and a computing device for managing a field that can alleviate at least one of the drawbacks of the prior art.

According to one aspect of the disclosure, the method is to be implemented by a computing device that stores a field image of the field. The field image has plural pixels. A color of each of the pixels of the field image is encoded under an RGB (red, green and blue) color model as a set of RGB channel values. The method includes steps of:

for each of the pixels of the field image, calculating a green index for quantifying green color of the pixel based on the set of RGB channel values of the pixel; performing a clustering algorithm on the pixels of the field image to group the pixels into a green cluster and a non-green cluster according to the green indexes respectively of the pixels of the field image, each pixel in the green cluster being regarded as green in view of the green index of the pixel, each pixel in the non-green cluster being regarded as non-green in view of the green index of the pixel; calculating one of a green-grass coverage indicating a ratio of an area of a portion of the field occupied by green grass to a total area of the field, and a green-grass vegetation index indicating an average of vegetation indexes in the portion occupied by green grass, the green-grass coverage being calculated at least based on a number of pixels in the green cluster and a total number of the pixels of the field image, the green-grass vegetation index being calculated at least based on the green indexes respectively of the pixels in the green cluster; and outputting the one of the green-grass coverage and the green-grass vegetation index to an irrigation system for the irrigation system to automatically maintain the field by one of irrigating the field and fertilizing the field based on the one of the green-grass coverage and the green-grass vegetation index.

According to another aspect of the disclosure, the computing device is electrically connected to an irrigation system. The computing device includes a storage and a processor. The storage is configured to store a field image of the field. The field image has plural pixels. A color of each of the pixels of the field image is encoded under an RGB (red, green and blue) color model as a set of RGB channel values. The processor is electrically connected to the storage. The processor is configured to, for each of the pixels of the field image, calculate a green index for quantifying green color of the pixel based on the set of RGB channel values of the pixel. The processor is further configured to perform a clustering algorithm on the pixels of the field image to group the pixels into a green cluster and a non-green cluster according to the green indexes respectively of the pixels of the field image. Each pixel in the green cluster is regarded as green in view of the green index of the pixel. Each pixel in the non-green cluster is regarded as non-green in view of the green index of the pixel. The processor is further configured to calculate one of a green-grass coverage indicating a ratio of an area of a portion of the field occupied by green grass to a total area of the field, and a green-grass vegetation index indicating an average of vegetation indexes in the portion occupied by green grass. The green-grass coverage is calculated at least based on a number of pixels in the green cluster and a total number of the pixels of the field image. The green-grass vegetation index is calculated at least based on the green indexes respectively of the pixels in the green cluster. The processor is further configured to output the one of the green-grass coverage and the green-grass vegetation index to the irrigation system for the irrigation system to automatically maintain the field by one of irrigating the field and fertilizing the field based on the one of the green-grass coverage and the green-grass vegetation index.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a computing device for management of a field according to an embodiment of the disclosure.

FIG. 2 is a flow chart illustrating a method for managing a field according to a first embodiment of the disclosure.

FIG. 3 is a flow chart illustrating a method for managing a field according to a second embodiment of the disclosure.

FIG. 4 is a flow chart illustrating a method for managing a field according to a third embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

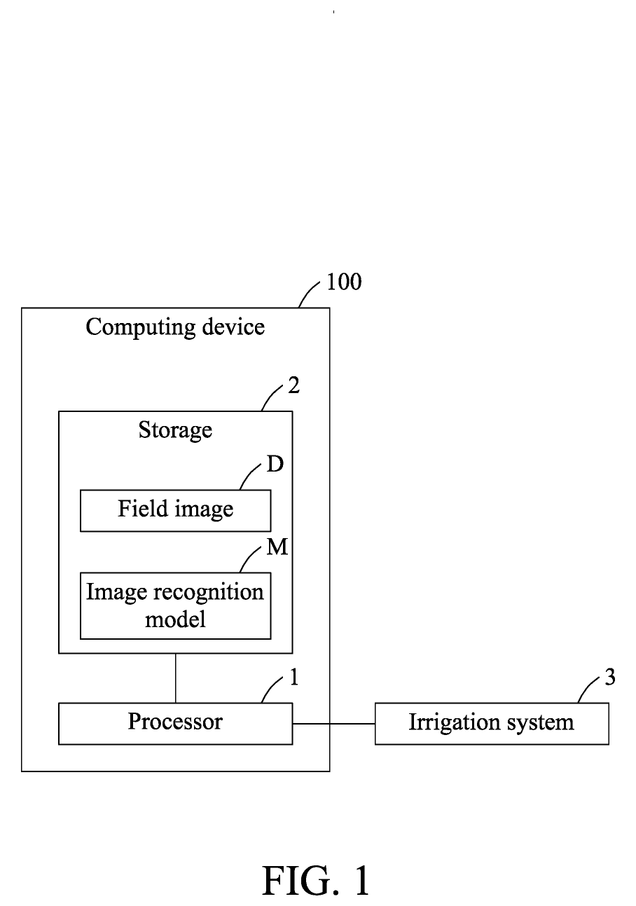

Referring to FIG. 1, an embodiment of a computing device 100 for management of a field according to the disclosure is illustrated. The computing device 100 may be implemented to be a computing server, a set of multiple computing servers, a desktop computer, a laptop computer, a notebook computer or a tablet computer, but implementation thereof is not limited to what are disclosed herein and may vary in other embodiments. The computing device 100 includes a storage 2, and a processor 1 that is electrically connected to the storage 2.

In this embodiment, the processor 1 may be implemented as a central processing unit (CPU), a microprocessor, a micro control unit (MCU), a single-core processor, a multi-core processor, a dual-core processor for a mobile device (e.g., a smartphone), a digital signal processor (DSP), a field-programmable gate array (FPGA), an application-specific integrated circuit (ASIC), a radio-frequency integrated circuit (RFIC), a system on a chip (SoC), or any circuit configurable/programmable in a software manner and/or hardware manner to implement functionalities discussed in this disclosure.

In this embodiment, the storage 2 may be implemented as random access memory (RAM), double data rate synchronous dynamic random access memory (DDR SDRAM), read only memory (ROM), programmable ROM (PROM), flash memory, a hard disk drive (HDD), a solid state disk (SSD), electrically-erasable programmable read-only memory (EEPROM) or any other volatile/non-volatile memory devices, but is not limited thereto. The storage 2 may be implemented to be supported by different kinds of computing devices. The storage 2 may be implemented as a combination of multiple storage media. Digital data can be stored in the storage 2.

The storage 2 is configured to store a field image (D) of the field. In this embodiment, the field image (D) is obtained by using a camera mounted on a mobile robot or a drone (i.e., an unmanned flying vehicle) to capture an image of the field, but is not limited thereto. The field image (D) has plural pixels. A color of each of the pixels of the field image (D) is encoded under an RGB (red, green and blue) color model as a set of RGB channel values. The set of RGB channel values includes a red channel value of the color, a green channel value of the color and a blue channel value of the color. The set of RGB channel values can be expressed as a three-tuple (R, G, B), where R represents the red channel value of the color, G represents the green channel value of the color, and B represents the blue channel value of the color. Since the RGB color model has been well known to one skilled in the relevant art, detailed explanation of the same is omitted herein for the sake of brevity.

The storage 2 is further configured to store an image recognition model (M). The image recognition model (M) is visual feature-based, is implemented as a software program for performing computer vision tasks, and can be loaded and executed by the processor 1. Specifically, the image recognition model (M) is a convolution neural network implemented by using techniques of semantic segmentation. For example, the image recognition model (M) may be a fully convolutional network (FCN), a SegNet model, a DeconvNet model, a DeepLab model or a RefineNet model, but is not limited to the disclosure herein and may vary in other embodiments. In some embodiments, the image recognition model (M) receives at least one pixel as an input, and outputs a classification result of said at least one pixel. In some embodiments, the image recognition model (M) receives all pixels of an input image, and outputs classification results respectively of the pixels of the input image. In one embodiment, each of the classification results indicates whether or not the corresponding one of the pixels of the input image is related to withered grass. In one embodiment, each of the classification results indicates whether or not the corresponding one of the pixels of the input image is related to bare soil. Since implementations of the image recognition model (M), including ways of training the image recognition model (M) and algorithms involved in the image recognition model (M), have been well known to one skilled in the relevant art, detailed explanation of the same is omitted herein for the sake of brevity.

The processor 1 is further electrically connected to an irrigation system 3. The irrigation system 3 may be implemented to include a sprinkler (not shown), a lawn mower (not shown), a fertilizer spreader (not shown) and so on, but is not limited to the disclosure herein and may vary in other embodiments. The irrigation system 3 may be implemented by using techniques of automation. The irrigation system 3 is configured to be controlled by the processor 1 of the computing device 100 to handle field-maintaining functionalities with reduced human intervention, e.g., to automatically irrigate a field or to fertilize a field. Since the techniques of automation have been well known to one skilled in the relevant art, detailed explanation of the same is omitted herein for the sake of brevity.

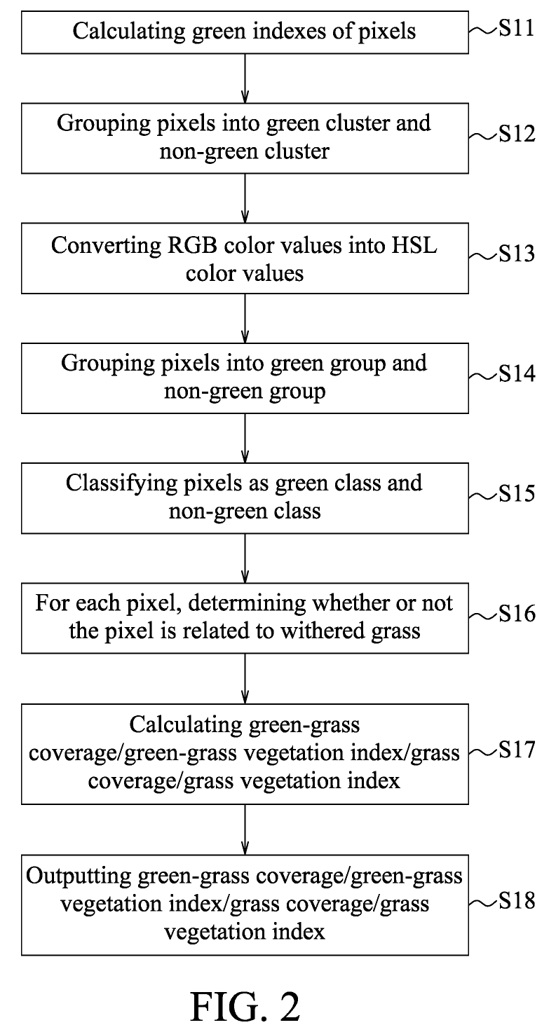

Referring to FIG. 2, a first embodiment of a method for managing a field according to the disclosure is illustrated. The method is to be implemented by the computing device 100 that is previously described. The method includes steps S11 to S18 delineated below.

In step S11, for each of the pixels of the field image (D), the processor 1 calculates a green index for quantifying green color of the pixel (for example, an excess green (ExG) index of the pixel in this embodiment, but is not limited thereto) based on the set of RGB channel values of the pixel. The ExG index is used to contrast a green portion of a spectrum of a color against a red portion and a blue portion of the spectrum. Specifically, the ExG index is calculated by using a formula: ExG = 2⋅g’ – r’ – b’, where ExG represents the ExG index, r’, g’ and b’ respectively represent normalized red, green and blue channel values, i.e., r’ = R/(R+G+B), g’ = G/(R+G+B), and b’ = B/(R+G+B).

In step S12, the processor 1 performs a clustering algorithm on the pixels of the field image (D) to group the pixels into a green cluster and a non-green cluster according to the ExG indexes respectively of the pixels of the field image (D). Each pixel in the green cluster is regarded as green in view of the ExG index of the pixel. Each pixel in the non-green cluster is regarded as non-green in view of the ExG index of the pixel. In this embodiment, the clustering algorithm is the k-means clustering algorithm, but is not limited thereto.

In step S13, for each of the pixels of the field image (D), the processor 1 converts, by using HSL (hue, saturation and lightness) representations, the set of RGB channel values of the pixel into a set of HSL color values. The set of HSL color values includes a hue channel value, a saturation channel value and a lightness channel value. Since the HSL representations have been well known to one skilled in the relevant art, detailed explanation of the same is omitted herein for the sake of brevity.

In step S14, for each of the pixels of the field image (D), the processor 1 determines whether the set of HSL color values of the pixel that was converted in step S13 falls in a predefined green range, groups the pixel into a green group in response to determining that the set of HSL color values of the pixel falls in the predefined green range, and groups the pixel into a non-green group in response to determining that the set of HSL color values of the pixel does not fall in the predefined green range. Each pixel in the green group is regarded as green in view of the set of HSL color values of the pixel. Each pixel in the non-green group is regarded as non-green in view of the set of HSL color values of the pixel. It should be noted that the predefined green range is defined according to practical needs and expertise.

In step S15, for each of the pixels of the field image (D), the processor 1 determines whether the pixel belongs to one of the green cluster and the green group, classifies the pixel as a green class in response to determining that the pixel belongs to any one of the green cluster and the green group, and classifies the pixel as a non-green class in response to determining that the pixel belongs to neither the green cluster nor the green group. Each pixel in the green class is regarded as green. Each pixel in the non-green class is regarded as non-green.

It is worthy of note that for a color of a considered pixel in an arbitrary image that is encoded under the RGB color model, a combination of the red channel value of the color, the green channel value of the color and the blue channel value of the color may be incapable of accurately reflecting an actual color of a portion of the field that corresponds to the considered pixel. That is to say, the set of RGB channel values of the color may not be a suitable basis for determining whether or not the color is actually green under influence of ambient light. Therefore, using the HSL representations to convert the set of RGB channel values into the set of HSL color values would provide an alternative basis for determining whether or not the color is green. For example, when the field image (D) is obtained by the camera mounted on the mobile robot or the drone in a dim condition, a result of determination made by the processor 1 as to whether or not a color of one pixel of the field image (D) is green based on the set of HSL channel values may be more accurate than that made based on the set of RGB channel values. Hence, it is possible to pick out more green pixels from the field image (D) under two different color spaces (i.e., making the aforesaid determinations based on the set of RGB channel values and the set of HSL channel values) than under a single one color space (e.g., making the aforesaid determinations based on either the set of RGB channel values or the set of HSL channel values).

In step S16, for each pixel of the non-green class, the processor 1 determines, by using the image recognition model (M) (i.e., loading the image recognition model (M) from the storage and executing the image recognition model (M)), whether or not the pixel is related to withered grass based on the set of RGB channel values of the pixel. In some embodiments, the processor 1 stores the classification result of the pixel outputted by the image recognition model (M) in the storage 2.

In step S17, the processor 1 calculates one of a green-grass coverage, a green-grass vegetation index, a grass coverage and a grass vegetation index. The green-grass coverage indicates a ratio of an area of a portion of the field occupied by green grass to a total area of the field, and is calculated at least based on a number of pixels in the green cluster and a total number of the pixels of the field image (D). In particular, the green-grass coverage is calculated based on a number of pixels of the green class and a total number of the pixels of the field image (D). Specifically, the processor 1 divides the number of pixels of the green class by the total number of the pixels of the field image (D) to obtain the green-grass coverage. The green-grass vegetation index indicates an average of vegetation indexes in the portion occupied by green grass, and is calculated at least based on the ExG indexes respectively of the pixels in the green cluster. In particular, the green-grass vegetation index is calculated based on the ExG indexes respectively of the pixels of the green class. Specifically, the processor 1 divides a sum of the ExG indexes respectively of the pixels of the green class by the number of pixels of the green class to obtain the green-grass vegetation index. The grass coverage indicates a ratio of an area of a portion of the field occupied by grass to the total area of the field. The grass coverage is calculated based on a number of pixels of the non-green class that were determined in step S16 to be related to withered grass (hereinafter also referred to as the withered-grass pixel number), the number of pixels of the green class and the total number of the pixels of the field image (D). Specifically, the processor 1 divides a sum of the withered-grass pixel number and the number of pixels of the green class by the total number of the pixels of the field image (D) to obtain the grass coverage. The grass vegetation index indicates an average of vegetation indexes in an area occupied by grass. The grass vegetation index is calculated based on the ExG indexes respectively of the pixels of the green class (hereinafter also referred to as the green ExG indexes) and the ExG indexes respectively of the pixels of the non-green class that were determined in step S16 to be related to withered grass (hereinafter also referred to as the withered-grass ExG indexes). Specifically, the processor 1 divides a sum of the green ExG indexes and the withered-grass ExG indexes by the sum of the withered-grass pixel number and the number of pixels of the green class to obtain the grass vegetation index.

In one embodiment, the processor 1 further calculates a total vegetation index based on the ExG indexes respectively of the pixels of the field image (D) and the total number of the pixels of the field image (D). Specifically, the processor 1 divides a sum of the ExG indexes respectively of the pixels of the field image (D) by the total number of the pixels of the field image (D) to obtain the total vegetation index. The total vegetation index indicates an average of vegetation indexes in the field.

In step S18, the processor 1 outputs the one of the green-grass coverage, the green-grass vegetation index, the grass coverage and the grass vegetation index to the irrigation system 3 for the irrigation system 3 to automatically maintain the field by one of irrigating the field and fertilizing the field based on the one of the green-grass coverage, the green-grass vegetation index, the grass coverage and the grass vegetation index.

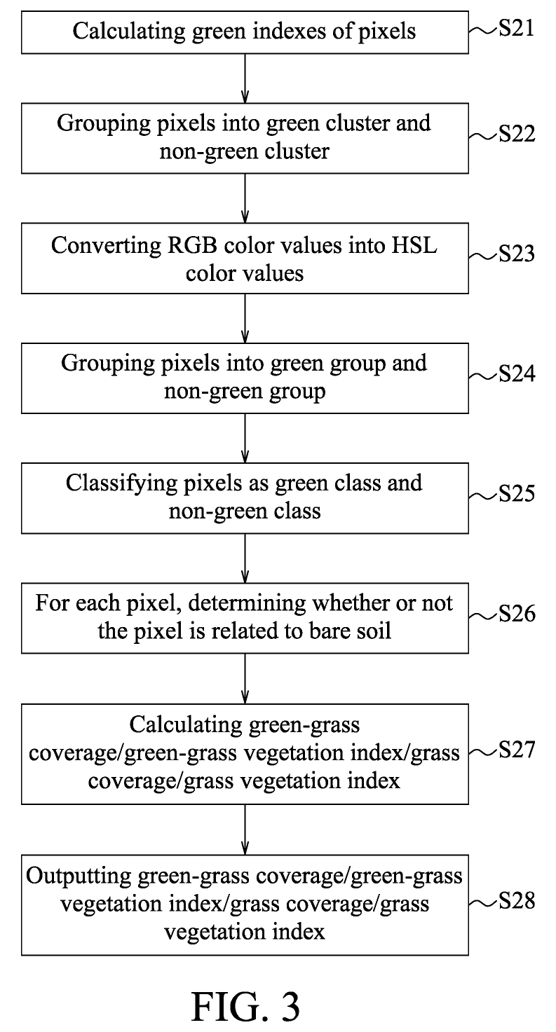

Referring to FIG. 3, a second embodiment of the method for managing a field according to the disclosure is illustrated. The method includes steps S21 to S28. Since steps S21 to S25, and S28 of the second embodiment of the method are similar respectively to steps S11 to S15, and S18 of the first embodiment of the method, only differences therebetween are described in the following.

In step S26, for each pixel of the non-green class, the processor 1 determines, by using the image recognition model (M), whether or not the pixel is related to bare soil based on the set of RGB channel values of the pixel. In some embodiments, the processor 1 stores the classification result of the pixel outputted by the image recognition model (M) in the storage 2.

In step S27, the processor 1 calculates one of the green-grass coverage, the green-grass vegetation index, the grass coverage and the grass vegetation index. Since the green-grass coverage and the green-grass vegetation index are calculated in the same ways as those in the first embodiment of the method, details thereof are omitted herein for the sake of brevity. The grass coverage is calculated based on a number of pixels of the non-green class that were determined in step S26 to be not related to bare soil (hereinafter also referred to as the non-bare-soil pixel number), the number of pixels of the green class and the total number of the pixels of the field image (D). Specifically, the processor 1 divides a sum of the non-bare-soil pixel number and the number of pixels of the green class by the total number of the pixels of the field image (D) to obtain the grass coverage. The grass vegetation index is calculated based on the ExG indexes respectively of the pixels of the green class (i.e., the green ExG indexes) and the ExG indexes respectively of the pixels of the non-green class that were determined in step S26 to be not related to bare soil (hereinafter also referred to as the non-bare-soil ExG indexes). Specifically, the processor 1 divides a sum of the green ExG indexes and the non-bare-soil ExG indexes by the sum of the non-bare-soil pixel number and the number of pixels of the green class to obtain the grass vegetation index.

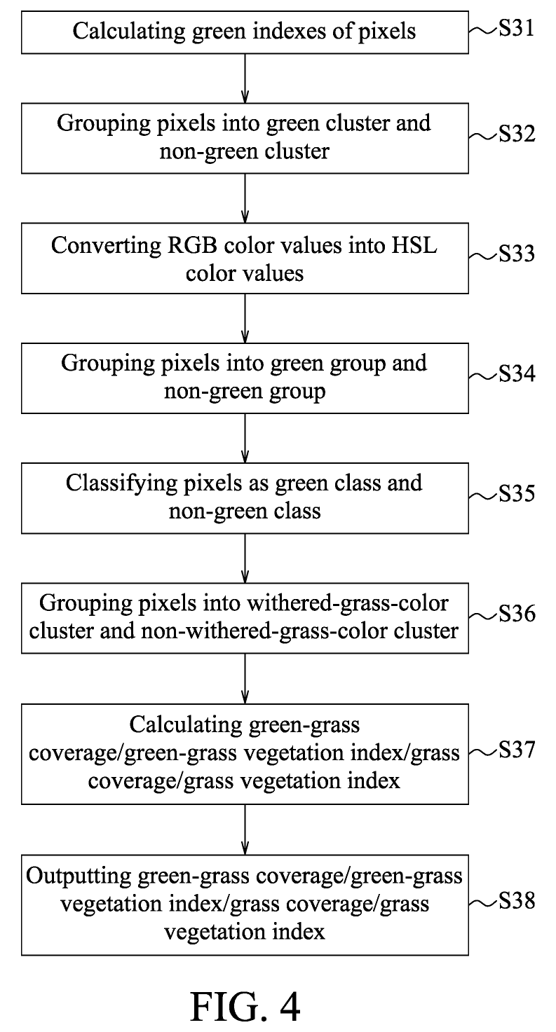

Referring to FIG. 4, a third embodiment of the method for managing a field according to the disclosure is illustrated. The method includes steps S31 to S38. Since steps S31 to S35, and S38 of the third embodiment of the method are similar respectively to steps S11 to S15, and S18 of the first embodiment of the method, only differences therebetween are described in the following.

In step S36, the processor 1 performs the clustering algorithm (i.e., the k-means clustering algorithm) on pixels of the non-green class to group the pixels into a withered-grass-color cluster and a non-withered-grass-color cluster according to the ExG indexes respectively of the pixels of the non-green class. Each pixel in the withered-grass-color cluster is regarded as having a color that is related to withered grass in view of the ExG index of the pixel. Each pixel in the non-withered-grass-color cluster is regarded as having a color that is not related to withered grass in view of the ExG index of the pixel.

In step S37, the processor 1 calculates one of the green-grass coverage, the green-grass vegetation index, the grass coverage and the grass vegetation index. Since the green-grass coverage and the green-grass vegetation index are calculated in the same ways as those in the first embodiment of the method, details thereof are omitted herein for the sake of brevity. The grass coverage is calculated based on a number of pixels in the withered-grass-color cluster, the number of pixels of the green class and the total number of the pixels of the field image (D). Specifically, the processor 1 divides a sum of the number of pixels in the withered-grass-color cluster and the number of pixels of the green class by the total number of the pixels of the field image (D) to obtain the grass coverage. The grass vegetation index is calculated based on the ExG indexes respectively of the pixels of the green class (i.e., the green ExG indexes) and the ExG indexes respectively of the pixels in the withered-grass-color cluster (hereinafter also referred to as the withered-grass-color ExG indexes). Specifically, the processor 1 divides a sum of the green ExG indexes and the withered-grass-color ExG indexes by the sum of the number of pixels in the withered-grass-color cluster and the number of pixels of the green class to obtain the grass vegetation index.

To sum up, for the method and the computing device 100 for managing a field according to the disclosure, ExG indexes respectively of all pixels of an field image of the field are calculated, and then the pixels are grouped, by using the clustering algorithm, into the green cluster and the non-green cluster according to the ExG indexes respectively of the pixels. Thereafter, one of the green-grass coverage and the green-grass vegetation index is calculated and outputted to the irrigation system 3 for controlling the irrigation system 3 to automatically maintain the field, e.g., to irrigate the field or to fertilize the field, based on the one of the green-grass coverage and the green-grass vegetation index. In this way, labor and time may be saved, and management of a field may become relatively more efficient and convenient.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for managing a field, to be implemented by a computing device that stores a field image of the field, the field image having plural pixels, a color of each of the pixels of the field image being encoded under an RGB (red, green and blue) color model as a set of RGB channel values, the method comprising:
for each of the pixels of the field image, calculating a green index for quantifying green color of the pixel based on the set of RGB channel values of the pixel;
performing a clustering algorithm on the pixels of the field image to group the pixels into a green cluster and a non-green cluster according to the green indexes respectively of the pixels of the field image, each pixel in the green cluster being regarded as green in view of the green index of the pixel, each pixel in the non-green cluster being regarded as non-green in view of the green index of the pixel;
calculating one of a green-grass coverage indicating a ratio of an area of a portion of the field occupied by green grass to a total area of the field, and a green-grass vegetation index indicating an average of vegetation indexes in the portion occupied by green grass, the green-grass coverage being calculated at least based on a number of pixels in the green cluster and a total number of the pixels of the field image, the green-grass vegetation index being calculated at least based on the green indexes respectively of the pixels in the green cluster; and
outputting the one of the green-grass coverage and the green-grass vegetation index to an irrigation system for the irrigation system to automatically maintain the field by one of irrigating the field and fertilizing the field based on the one of the green-grass coverage and the green-grass vegetation index.

2. The method as claimed in claim 1, further comprising, for each of the pixels of the field image:
converting, by using HSL (hue, saturation and lightness) representations, the set of RGB channel values of the pixel into a set of HSL color values;
determining whether the set of HSL color values of the pixel falls in a predefined green range;
in response to determining that the set of HSL color values of the pixel falls in the predefined green range, grouping the pixel into a green group, each pixel in the green group being regarded as green in view of the set of HSL color values of the pixel;
in response to determining that the set of HSL color values of the pixel does not fall in the predefined green range, grouping the pixel into a non-green group, each pixel in the non-green group being regarded as non-green in view of the set of HSL color values of the pixel;
determining whether the pixel belongs to one of the green cluster and the green group;
in response to determining that the pixel belongs to any one of the green cluster and the green group, classifying the pixel as a green class, each pixel in the green class being regarded as green;
in response to determining that the pixel belongs to neither the green cluster nor the green group, classifying the pixel as a non-green class, each pixel in the non-green class being regarded as non-green,
wherein, in calculating one of a green-grass coverage and a green-grass vegetation index, the green-grass coverage is calculated based on a number of pixels of the green class and the total number of the pixels of the field image, and the green-grass vegetation index is calculated based on the green indexes respectively of the pixels of the green class.

3. The method as claimed in claim 2, the computing device further storing an image recognition model, the method further comprising:
for each pixel of the non-green class, determining, by using the image recognition model, whether or not the pixel is related to withered grass based on the set of RGB channel values of the pixel;
calculating one of a grass coverage indicating a ratio of an area of a portion of the field occupied by grass to the total area of the field, and a grass vegetation index indicating an average of vegetation indexes in an area occupied by grass, the grass coverage being calculated based on a number of pixels of the non-green class that are determined to be related to withered grass, the number of pixels of the green class and the total number of the pixels of the field image, the grass vegetation index being calculated based on the green indexes respectively of the pixels of the green class and the green indexes respectively of the pixels of the non-green class that are determined to be related to withered grass; and
outputting the one of the grass coverage and the grass vegetation index to the irrigation system for the irrigation system to automatically maintain the field by one of irrigating the field and fertilizing the field based on the one of the grass coverage and the grass vegetation index.

4. The method as claimed in claim 2, the computing device further storing an image recognition model, the method further comprising:
for each pixel of the non-green class, determining, by using the image recognition model, whether or not the pixel is related to bare soil based on the set of RGB channel values of the pixel;
calculating one of a grass coverage indicating a ratio of an area of a portion of the field occupied by grass to the total area of the field, and a grass vegetation index indicating an average of vegetation indexes in an area occupied by grass, the grass coverage being calculated based on a number of pixels of the non-green class that are determined to be not related to bare soil, the number of pixels of the green class and the total number of the pixels of the field image, the grass vegetation index being calculated based on the green indexes respectively of the pixels of the green class and the green indexes respectively of the pixels of the non-green class that are determined to be not related to bare soil; and
outputting the one of the grass coverage and the grass vegetation index to the irrigation system for the irrigation system to automatically maintain the field by one of irrigating the field and fertilizing the field based on the one of the grass coverage and the grass vegetation index.

5. The method as claimed in claim 2, further comprising:
performing the clustering algorithm on pixels of the non-green class to group the pixels into a withered-grass-color cluster and a non-withered-grass-color cluster according to the green indexes respectively of the pixels of the non-green class, each pixel in the withered-grass-color cluster being regarded as having a color that is related to withered grass in view of the green index of the pixel, each pixel in the non-withered-grass-color cluster being regarded as having a color that is not related to withered grass in view of the green index of the pixel;
calculating one of a grass coverage indicating a ratio of an area of a portion of the field occupied by grass to the total area of the field, and a grass vegetation index indicating an average of vegetation indexes in an area occupied by grass, the grass coverage being calculated based on a number of pixels in the withered-grass-color cluster, the number of pixels of the green class and the total number of the pixels of the field image, the grass vegetation index being calculated based on the green indexes respectively of the pixels of the green class and the green indexes respectively of the pixels in the withered-grass-color cluster; and
outputting the one of the grass coverage and the grass vegetation index to the irrigation system for the irrigation system to automatically maintain the field by one of irrigating the field and fertilizing the field based on the one of the grass coverage and the grass vegetation index.

6. The method as claimed in claim 1, further comprising calculating a total vegetation index by dividing a sum of the green indexes respectively of the pixels of the field image by the total number of the pixels of the field image, the total vegetation index indicating an average of vegetation indexes in the field.

7. A computing device for management of a field, said computing device electrically connected to an irrigation system and comprising:
a storage configured to store a field image of the field, the field image having plural pixels, a color of each of the pixels of the field image being encoded under an RGB (red, green and blue) color model as a set of RGB channel values; and
a processor electrically connected to said storage, and configured to,
for each of the pixels of the field image, calculate a green index for quantifying green color of the pixel based on the set of RGB channel values of the pixel,
perform a clustering algorithm on the pixels of the field image to group the pixels into a green cluster and a non-green cluster according to the green indexes respectively of the pixels of the field image, each pixel in the green cluster being regarded as green in view of the green index of the pixel, each pixel in the non-green cluster being regarded as non-green in view of the green index of the pixel,
calculate one of a green-grass coverage indicating a ratio of an area of a portion of the field occupied by green grass to a total area of the field, and a green-grass vegetation index indicating an average of vegetation indexes in the portion occupied by green grass, the green-grass coverage being calculated at least based on a number of pixels in the green cluster and a total number of the pixels of the field image, the green-grass vegetation index being calculated at least based on the green indexes respectively of the pixels in the green cluster; and
output the one of the green-grass coverage and the green-grass vegetation index to the irrigation system for the irrigation system to automatically maintain the field by one of irrigating the field and fertilizing the field based on the one of the green-grass coverage and the green-grass vegetation index.

8. The computing device as claimed in claim 7, wherein said processor is further configured to, for each of the pixels of the field image:
convert, by using HSL (hue, saturation and lightness) representations, the set of RGB channel values of the pixel into a set of HSL color values;
determine whether the set of HSL color values of the pixel falls in a predefined green range;
in response to determining that the set of HSL color values of the pixel falls in the predefined green range, group the pixel into a green group, each pixel in the green group being regarded as green in view of the set of HSL color values of the pixel;
in response to determining that the set of HSL color values of the pixel does not fall in the predefined green range, group the pixel into a non-green group, each pixel in the non-green group being regarded as non-green in view of the set of HSL color values of the pixel;
determine whether the pixel belongs to one of the green cluster and the green group;
in response to determining that the pixel belongs to any one of the green cluster and the green group, classify the pixel as a green class, each pixel in the green class being regarded as green;
in response to determining that the pixel belongs to neither the green cluster nor the green group, classify the pixel as a non-green class, each pixel in the non-green class being regarded as non-green,
wherein said processor is configured to calculate the green-grass coverage based on a number of pixels of the green class and the total number of the pixels of the field image, and to calculate the green-grass vegetation index based on the green indexes respectively of the pixels of the green class.

9. The computing device as claimed in claim 8, wherein:
said storage is further configured to store an image recognition model; and
said processor is further configured to,
for each pixel of the non-green class, determine, by using the image recognition model, whether or not the pixel is related to withered grass based on the set of RGB channel values of the pixel,
calculate one of a grass coverage indicating a ratio of an area of a portion of the field occupied by grass to the total area of the field, and a grass vegetation index indicating an average of vegetation indexes in an area occupied by grass, the grass coverage being calculated based on a number of pixels of the non-green class that are determined to be related to withered grass, the number of pixels of the green class and the total number of the pixels of the field image, the grass vegetation index being calculated based on the green indexes respectively of the pixels of the green class and the green indexes respectively of the pixels of the non-green class that are determined to be related to withered grass, and
output the one of the grass coverage and the grass vegetation index to the irrigation system for the irrigation system to automatically maintain the field by one of irrigating the field and fertilizing the field based on the one of the grass coverage and the grass vegetation index.

10. The computing device as claimed in claim 8,
said storage is further configured to store an image recognition model; and
said processor is further configured to,
for each pixel of the non-green class, determine, by using the image recognition model, whether or not the pixel is related to bare soil based on the set of RGB channel values of the pixel,
calculate one of a grass coverage indicating a ratio of an area of a portion of the field occupied by grass to the total area of the field, and a grass vegetation index indicating an average of vegetation indexes in an area occupied by grass, the grass coverage being calculated based on a number of pixels of the non-green class that are determined to be not related to bare soil, the number of pixels of the green class and the total number of the pixels of the field image, the grass vegetation index being calculated based on the green indexes respectively of the pixels of the green class and the green indexes respectively of the pixels of the non-green class that are determined to be not related to bare soil, and
output the one of the grass coverage and the grass vegetation index to the irrigation system for the irrigation system to automatically maintain the field by one of irrigating the field and fertilizing the field based on the one of the grass coverage and the grass vegetation index.

11. The computing device as claimed in claim 8, wherein said processor is further configured to:
perform the clustering algorithm on pixels of the non-green class to group the pixels into a withered-grass-color cluster and a non-withered-grass-color cluster according to the green indexes respectively of the pixels of the non-green class, each pixel in the withered-grass-color cluster being regarded as having a color that is related to withered grass in view of the green index of the pixel, each pixel in the non-withered-grass-color cluster being regarded as having a color that is not related to withered grass in view of the green index of the pixel;
calculate one of a grass coverage indicating a ratio of an area of a portion of the field occupied by grass to the total area of the field, and a grass vegetation index indicating an average of vegetation indexes in an area occupied by grass, the grass coverage being calculated based on a number of pixels in the withered-grass-color cluster, the number of pixels of the green class and the total number of the pixels of the field image, the grass vegetation index being calculated based on the green indexes respectively of the pixels of the green class and the green indexes respectively of the pixels in the withered-grass-color cluster; and
output the one of the grass coverage and the grass vegetation index to the irrigation system for the irrigation system to automatically maintain the field by one of irrigating the field and fertilizing the field based on the one of the grass coverage and the grass vegetation index.

12. The computing device as claimed in claim 7, wherein said processor is further configured to calculate a total vegetation index by dividing a sum of the green indexes respectively of the pixels of the field image by the total number of the pixels of the field image, the total vegetation index indicating an average of vegetation indexes in the field.
